(19) United States
(12) Patent Application Publication
(10) Pub. No.: US 2025/0211899 A1
(43) Pub. Date: Jun. 26, 2025

(54) SOUND SYSTEM

(71) Applicant: NIPPON TELEGRAPH AND TELEPHONE CORPORATION, Tokyo (JP)

(72) Inventors: Masahiro FUKUI, Tokyo (JP); Kazunori KOBAYASHI, Tokyo (JP); Noriyoshi KAMADO, Tokyo (JP); Yohei WAKISAKA, Tokyo (JP)

(73) Assignee: NIPPON TELEGRAPH AND TELEPHONE CORPORATION, Tokyo (JP)

(21) Appl. No.: 18/849,024

(22) PCT Filed: Mar. 28, 2022
(86) PCT No.: PCT/JP2022/014993

§ 371 Date: Sep. 20, 2024

(51) Int. Cl. H04R 1/40; G10K 11/178; H04R 1/02; H04R 3/12; H04R 5/02

(52) U.S. Cl. CPC H04R 1/403; G10K 11/178; H04R 1/025; H04R 3/12; H04R 5/023; G10K 2210/1281; H04R 2499/13

(57) ABSTRACT

A sound system capable of reproducing a sound that is not heard around the user is provided while reducing movement of a position of a speaker system or a position of a user's head. The sound system includes a directivity control device, and a speaker system that includes at least one speaker unit pair that includes a positive speaker for emitting a sound based on a first processed acoustic signal and a negative speaker for emitting a sound based on a second processed acoustic signal. The positive speaker and the negative speaker do not include a speaker box, the signal processing executed by a directivity control unit is processing that gives directivity to the sound emitted by the speaker unit pair, and the directivity of the sound emitted by the speaker unit pair is controlled depending on a position where an auditory organ of the user exists, and a position where the speaker unit pair exists.

### TECHNICAL FIELD

The present invention relates to a sound localized reproduction technique.

### BACKGROUND ART

There is a technique for realizing localized reproduction of an acoustic signal by using at least two speakers as a pair (refer to PTL 1).

### CITATION LIST

### Patent Literature

### [PTL 1] WO 2021/192166

### SUMMARY OF INVENTION

### Technical Problem

In NPL 1, a technique is disclosed in which a plurality of speakers can be heard by a user only at a localized location in a vicinity of a speaker system by utilizing bi-directivity of the speakers without using a speaker box.

Since the technique described in NPL 1 allows the user to view only in the vicinity of the speaker system, an audible region need to be set in consideration of a position of the speaker system and a position of a user's head for listening (particularly, a position of an ear).

Therefore, in the present invention, it is an object to provide a sound system capable of reproducing a sound that is not heard around the user while reducing movement of a position of the speaker system or a position of the user's head.

### Solution to Problem

In an aspect of the present invention, a sound system includes a directivity control device that includes at least one directivity control unit that generates a first processed acoustic signal from an acoustic signal (hereinafter referred to as a first acoustic signal) of a predetermined sound source and a second processed acoustic signal from an acoustic signal (hereinafter referred to as a second acoustic signal) having an opposite phase to that of the first acoustic signal by executing predetermined signal processing and a speaker system that includes at least one speaker unit pair that includes a speaker (hereinafter referred to as a positive speaker) that emits a sound based on the first processed acoustic signal and a speaker (hereinafter referred to as a negative speaker) that emits a sound based on the second processed acoustic signal. The positive speaker and the negative speaker do not include a speaker box, the signal processing executed by the directivity control unit is processing that gives directivity to the sound emitted by the speaker unit pair, and the directivity of the sound emitted by the speaker unit pair is controlled depending on a position where an auditory organ of a user exists, and a position where the speaker unit pair exists.

### Advantageous Effects of Invention

According to the present invention, it is possible to reproduce a sound that can be heard only in a limited narrow range while reducing movement of a position of a speaker system or a position of a user.

### BRIEF DESCRIPTION OF DRAWINGS

FIG. 1 is a diagram for explaining directivity of a sound emitted from a speaker.

FIG. 2 is a diagram for explaining directivity of a sound emitted from a speaker unit.

FIG. 3 is a diagram for explaining a sound emitted from a speaker unit pair.

FIG. 4 is a diagram for explaining directivity of the sound emitted from the speaker unit pair.

FIG. 5 is a diagram showing a situation of experiment (positional relationship between a speaker and a microphone).

FIG. 6 is a diagram showing a situation of experiment (positional relationship between a speaker unit and a microphone).

FIG. 7 is a diagram showing a situation of experiment (positional relationship between a speaker unit pair and a microphone).

FIG. 8 is a diagram showing a situation of experiment (other measurement points).

FIG. 9 is a diagram showing experiment results (condition 1).

FIG. 10 is a diagram showing experiment results (condition 2).

FIG. 11 is a diagram showing experiment results (condition 3).

FIG. 12 is a diagram showing experiment results (condition 4).

FIG. 13 is a diagram showing an example of a sound system installed in a seat of an aircraft.

FIG. 14 is a block diagram showing an example of a configuration of a sound system 100.

FIG. 15 is a diagram showing a situation of the sound emitted from the speaker unit pair.

FIG. 16 is a block diagram showing an example of a configuration of a sound system 200.

FIG. 17 is a block diagram showing an example of a configuration of a sound system 202.

FIG. 18 is a diagram showing an example of a configuration of a speaker unit pair 122 to which a member 1224 is attached.

FIG. 19 is a diagram showing an example of a sound system installed in a seat of an automobile.

FIG. 20 is a diagram showing an example of the sound system installed in the seat of the automobile.

FIG. 21 is a diagram showing an example of the sound system installed in the seat of the aircraft.

FIG. 22 is a block diagram showing an example of a configuration of a sound system 300.

FIG. 23 is a diagram for explaining directivity of a sound emitted from a speaker unit.

FIG. 24 is a diagram for explaining the directivity of the sound emitted from the speaker unit.

FIG. 25 is a diagram for explaining the directivity of the sound emitted from the speaker unit.

FIG. 26 is a diagram for explaining the directivity of the sound emitted from the speaker unit.

FIG. 27 is a diagram showing an example of the sound system installed in the seat of the aircraft.

FIG. 28 is a diagram for explaining the directivity of the sound emitted from the speaker unit.

FIG. 29 is a diagram showing an example of the sound system installed in the seat of the aircraft.

FIG. 30 is a diagram for explaining the directivity of the sound emitted from the speaker unit.

FIG. 31 is a diagram showing an example of the sound system installed in the seat of the aircraft.

FIG. 32 is a diagram for explaining the directivity of the sound emitted from the speaker unit.

FIG. 33 is a diagram for explaining the directivity of the sound emitted from the speaker unit.

FIG. 34 is a diagram for explaining the directivity of the sound emitted from the speaker unit.

FIG. 35 is a diagram for explaining the directivity of the sound emitted from the speaker unit.

FIG. 36 is a diagram showing an example of the sound system installed in the seat of the aircraft.

FIG. 37 is a diagram for explaining the directivity of the sound emitted from the speaker unit.

FIG. 38 is a diagram showing an example of the sound system installed in the seat of the aircraft.

FIG. 39 is a diagram for explaining the directivity of the sound emitted from the speaker unit.

FIG. 40 is a diagram for explaining the directivity of the sound emitted from the speaker unit.

FIG. 41 is a diagram for explaining the directivity of the sound emitted from the speaker unit.

FIG. 42 is a diagram for explaining the directivity of the sound emitted from the speaker unit.

FIG. 43 is a diagram showing an example of the sound system installed in the seat of the aircraft.

FIG. 44 is a diagram showing an example of the sound system installed in the seat of the aircraft.

### DESCRIPTION OF EMBODIMENTS

The following describes embodiments of the present invention in detail. Note that components having the same function will be denoted by the same reference numerals and redundant description thereof will be omitted.

### Technical Background

First, directivity of a sound emitted from a speaker will be described. Next, the directivity of the sound emitted from the speaker unit pair according to the present invention of the application will be described. Finally, results of experiments for confirming effects of the speaker unit pair according to the present invention of the application will be described.

### 1: Directivity of Sound Emitted From Speaker

Usually, the speaker is composed of a speaker unit and a speaker box. The speaker unit is a component that includes a diaphragm that converts acoustic signals, which are electric signals, into air vibrations (that is, generates sound waves). In addition, the speaker box is a component that houses the speaker unit.

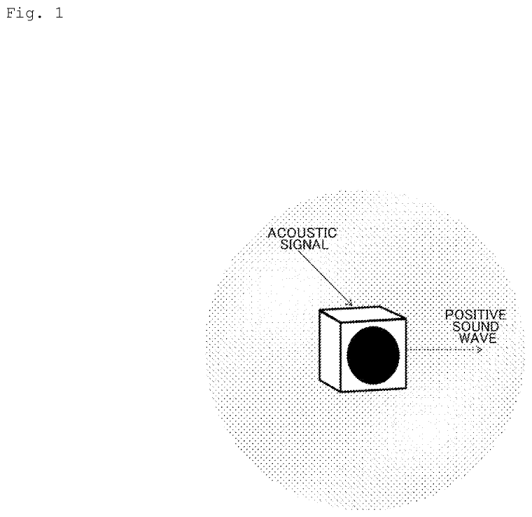

When the acoustic signal is inputted to the speaker, the diaphragm of the speaker unit vibrates, and sound waves are radiated in both directions in which the diaphragm vibrates. Here, the sound wave radiated to the outside of the speaker box (that is, the front direction of the speaker unit) is referred to as a positive sound wave, and the sound wave radiated to the inside of the speaker box (that is, the back direction of the speaker unit) is referred to as a negative sound wave. The negative sound wave is a sound wave that has an opposite phase to that of the positive sound wave. FIG. 1 is a diagram for explaining the directivity of the sound emitted from the speaker. As shown in FIG. 1, the positive sound wave is radiated from the speaker in all directions, while the negative sound wave is not radiated to the outside of the speaker box. As a result, the sound emitted from the speaker can be heard over a wide range.

### 2: Directivity of Sound Emitted From Speaker Unit Pair

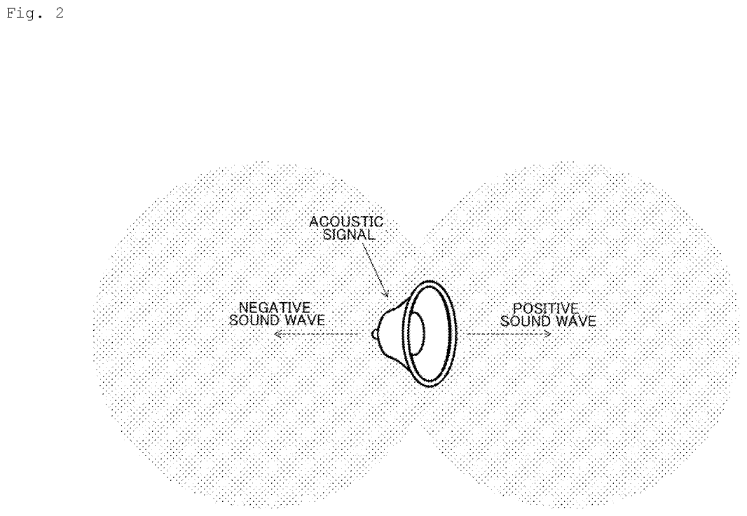

Here, the directivity of the sound emitted from the speaker unit which is a bare speaker will be described first. FIG. 2 is a diagram for explaining an example of the directivity of the sound emitted from the speaker unit. In the case of only the speaker unit, the negative sound wave is radiated from a back of the speaker unit hidden in the speaker box differently from the case of the speaker. Therefore, as shown in FIG. 2, the sound emitted from the speaker unit has a characteristic of bi-directivity.

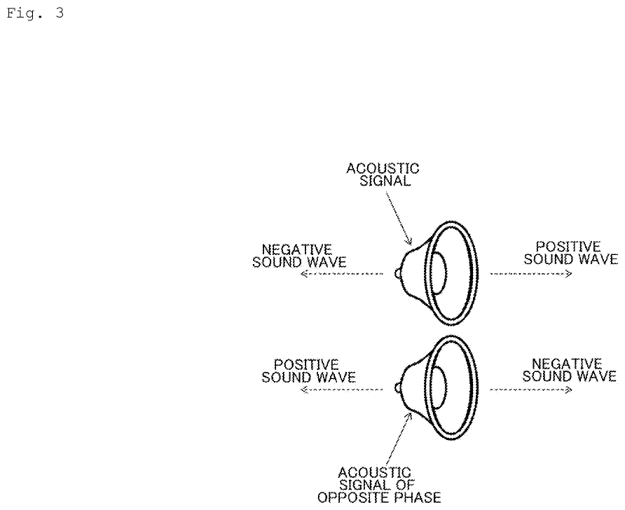

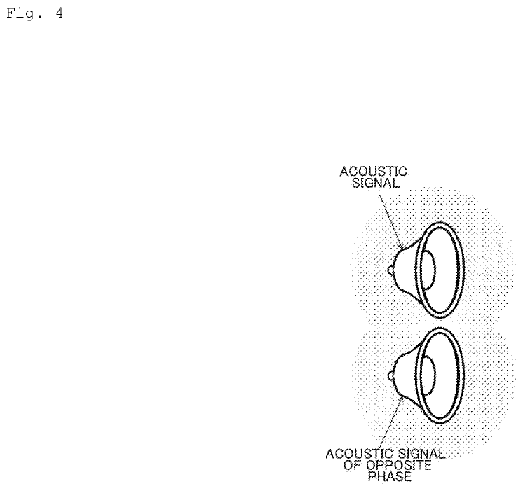

In the present invention of the application, the bi-directivity is utilized. This is described specifically hereinafter. First, as shown in FIG. 3, two speaker units are arranged to form a speaker unit pair. The two speaker units are arranged so as to emit the sound in substantially the same direction. When acoustic signals having substantially the same size and opposite phase relation are inputted to the speaker unit pair respectively, the diaphragms of the two speaker units are vibrated respectively, and sounds based on the two acoustic signals are emitted. Then, the sound released from the speaker unit pair is suppressed largely except a vicinity of the speaker unit pair, and the sound pressure approaches 0 as much as possible. For example, in FIG. 4, the sound is not erased in a point region in the vicinity of the speaker unit, but a state in which the sound cannot be heard is created outside the point region. That is, the sound is erased only at a position sufficiently distant from the speaker unit pair, and the sound is not erased in the vicinity of the speaker unit pair. The reason why the sound is not erased in the vicinity of the speaker unit pair is that when the sound waves released from each of the speaker unit pair are overlapped at an observation point, influence of a distance based on an arrival route from each speaker unit to the observation point is large. Although the effect of canceling the phase by overlapping the positive and negative directions is obtained at the far distance where the influence of the route difference due to the interval and the wraparound of the speaker unit pair is small, the route difference to an arrival between the sound wave radiated from the front of the speaker unit and the sound wave sneaking from the back is large in the vicinity of the speaker unit pair, and the positive and negative of the phases do not overlap in an exact opposite relation.

That is, when a predetermined acoustic signal is inputted to one speaker unit constituting the speaker unit pair and an acoustic signal having an opposite phase to that of the predetermined acoustic signal is inputted to the other speaker unit, it is possible to create a situation in which only a user in the vicinity of the speaker unit pair can hear and other users cannot hear the sound by utilizing a characteristic in which the sound can be heard in the vicinity of the speaker unit pair.

### 3: Experiment Result

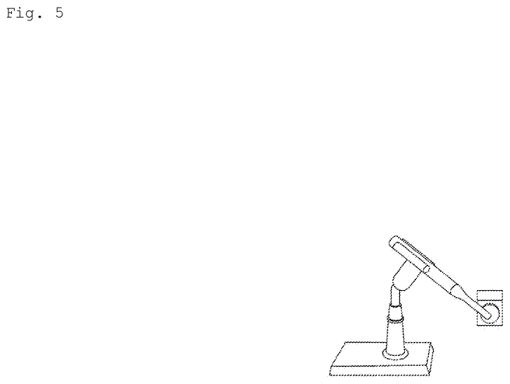

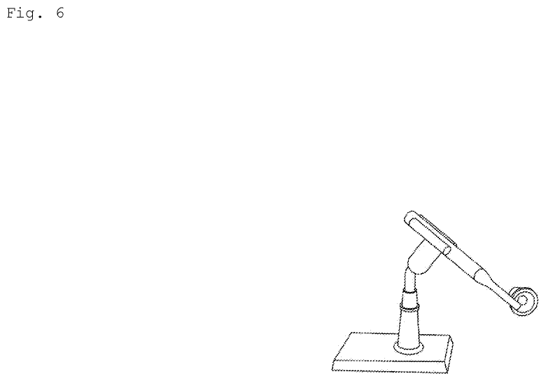

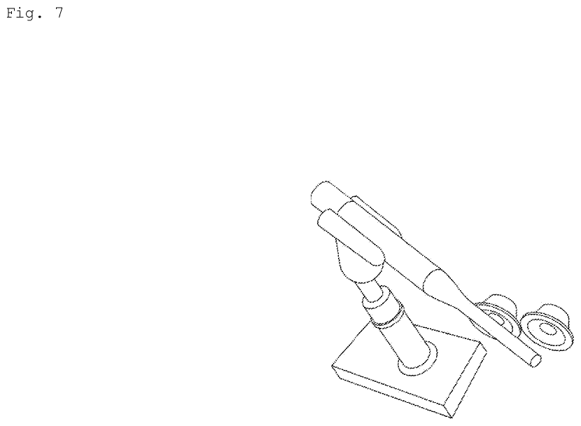

Here, results of experiments that measure frequency characteristics of the speaker, the speaker unit, and the speaker unit pair will be described. In the experiment, as the speaker, the speaker unit, and the speaker unit pair, a speaker having a diaphragm of 4.5 cm in a diameter (see FIG. 5), a speaker unit in which the speaker box is removed from the speaker (see FIG. 6), and a speaker unit pair in which two speaker units are arranged (see FIG. 7) are used. In addition, in order to measure the frequency characteristics in the vicinity of the speaker, the speaker unit, and the speaker unit pair, a microphone is installed under the following four conditions.
(Condition 1) a position of 5 cm from the front of the speaker
(Condition 2) a position of 5 cm from the front of the speaker unit
(Condition 3) a position of 2 cm from the front of the speaker unit
(Condition 4) a position of 2 cm from the front of the speaker unit pair

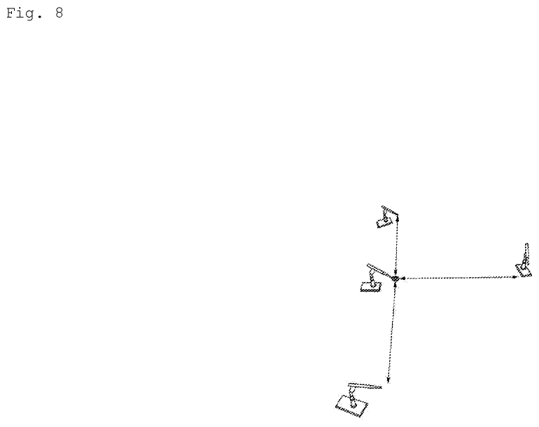

Also, for each of the conditions, for comparison, microphones are also installed at positions of 100 cm from each of the front, back, and side of the speaker, the speaker unit, and the speaker unit pair (see FIG. 8).

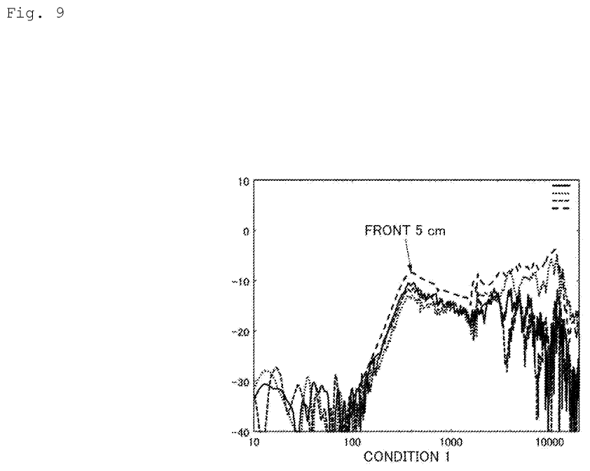

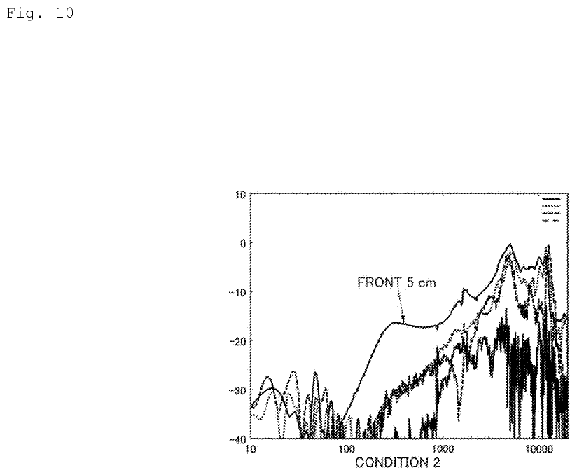

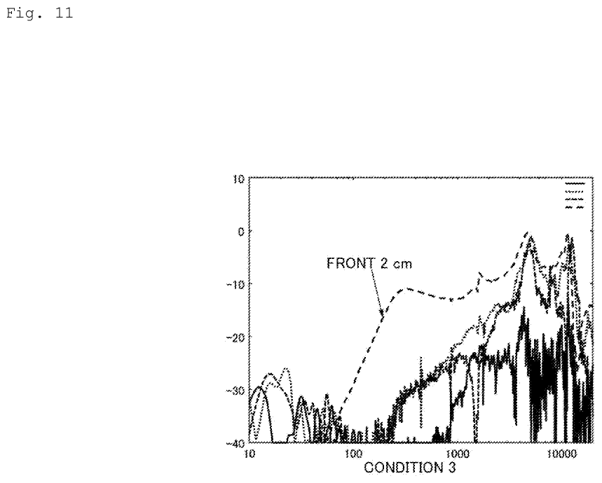

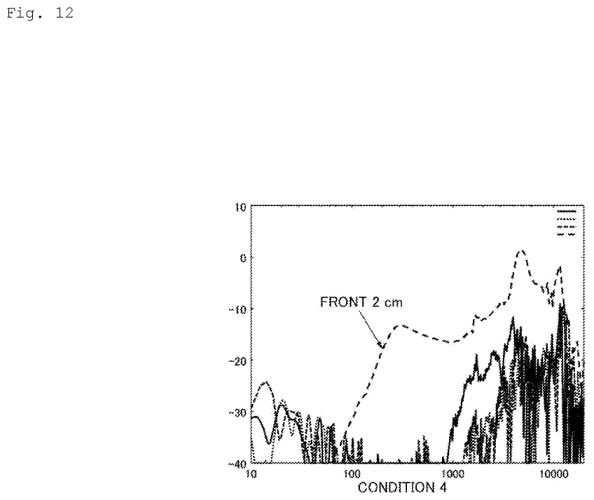

Hereinafter, the experiment results will be described. FIG. 9, FIG. 10, FIG. 11 and FIG. 12 are diagrams showing the experiment results, and showing relationships between the frequency and the attenuation under the condition 1, condition 2, condition 3, and condition 4, respectively. In all figures, four curves are shown, one curve indicated by an arrow is the experiment result in which the sound is collected by a microphone located at a position of 5 cm or 2 cm from the front, and other three curves are the experiment results in which the sounds are collected by the microphones located at a position of 100 cm from the front, the back, and the side. Note that since the curve at the position of 5 cm or 2 cm from the front is located in the vicinity of the speaker or the like, the gain becomes very large. Therefore, in order to make it easy to see, the curve at the position of 5 cm from the front is plotted by −25 dB from three curves at the position of 100 cm. Similarly, the curve at 2 cm from the front is plotted at −32 dB. Comparing FIG. 9 and FIG. 10, it can be seen that there is almost no difference between the four curves when the speaker is used, and there is a difference between the curve at the position of 5 cm from the front and other three curves when the speaker unit is used. This difference is more remarkable as it is in a lower region. Also, comparing FIG. 11 and FIG. 12, it can be seen that the speaker unit pair has a larger difference between the curve at the position of 2 cm from the front and other three curves than that of the speaker unit.

As described above, it was confirmed by the experiments that the sound emitted from the speaker unit pair of the present invention of the application was heard only in the vicinity of the speaker unit pair.

### First Embodiment

A system that reproduces an acoustic signal obtained based on a reproduction object is called a sound system. The sound system includes a speaker system in order to emit the acoustic signal as the sound (hereinafter, this sound is referred to as a sound based on the acoustic signal). Here, the speaker system is a device that converts the acoustic signal, which is an analogue signal, into the sound. In addition, the reproduction objects are data and signal in which the acoustic signal can be obtained by the predetermined processing, for example, such as data recorded in a CD, a DVD, and a record, data received by the Internet, and signals received by radio broadcasting and television broadcasting.

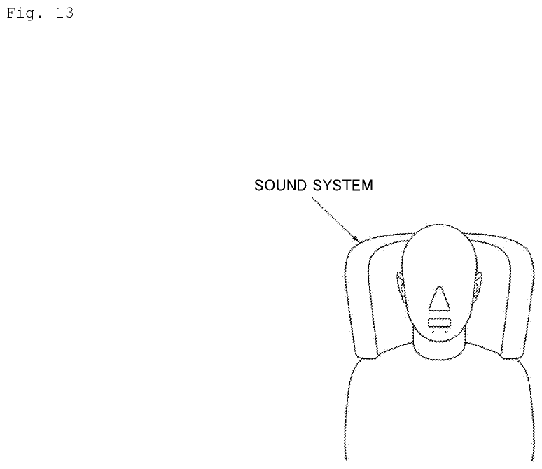

Here, the sound system in which the sound based on the acoustic signal obtained from the reproduction objects is reproduced so as to be heard only by a user in the vicinity of the speaker system will be described. That is, the reproduced sound of the sound system is not heard by users other than the user in the vicinity of the speaker system. When such a sound system is used as a sound system for a user who uses a seat of an aircraft, for example, a system can be provided which allows only the user who uses the seat to hear the reproduced sound. FIG. 13 is a diagram showing an example of the sound system installed in the seat of the aircraft. The sound system shown in FIG. 13 is installed on the seat so as to sandwich a seated user's head, and two speaker unit pairs are arranged in the vicinity of the left and right ears. Note that such a sound system can be installed in a vehicle other than the aircraft such as an automobile and an electric train, or a reclining chair, and it can be installed even in a wearable form such as putting on a shoulder. Further, a driver unit pair, which corresponds to the speaker unit pair and is formed by arranging two driver units, may be installed in the left and right units of a headphone and an earphone. The headphones are generally divided into two types of open type (open air type) and closed type (closed type), but it is expected that sound leakage is reduced if the above-mentioned technique is applied to the open type having a risk of sound leakage.

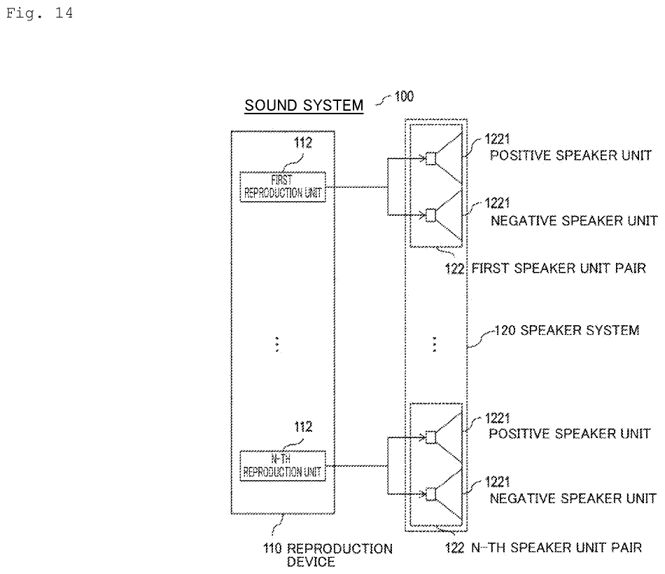

Hereinafter, a sound system 100 will be described with reference to FIG. 14. FIG. 14 is a block diagram showing a configuration of the sound system 100. As shown in FIG. 14, the sound system 100 includes a reproduction device 110 and a speaker system 120. The reproduction device 110 includes N pieces (where N is an integer of 1 or more) of reproduction units 112 (that is, a first reproduction unit 112, . . . , and an N-th reproduction unit 112). Further, the speaker system 120 includes N pieces of speaker unit pairs 122 (that is, a first speaker unit pair 122, . . . , and an N-th speaker unit pair 122). The speaker unit pair 122 includes two speaker units (that is, a positive speaker unit 1221 and a negative speaker unit 1221). The negative speaker unit 1221 inputs the acoustic signal having an opposite phase to that of the acoustic signal inputted to the positive speaker unit 1221. The speaker system 120 is installed at a place near a head of the user who uses the seat.

Note that the direction in which the n-th speaker unit pair 122 faces the user is defined as an n-th user direction (n=1, . . . , N), and the positive speaker unit 1221 and the negative speaker unit 1221 of the n-th speaker unit pair 122 (n=1, . . . , N) are arranged so that the sound emitted in the opposite direction to the n-th user direction from the positive speaker unit 1221 and the sound emitted in the opposite direction to the n-th user direction from the negative speaker unit 1221 are transmitted in the n-th user direction by the wraparound. Here, the n-th user direction is the front direction of the positive speaker unit 1221 and the negative speaker unit 1221 of the n-th speaker unit pair 122. In addition, the opposite direction to the n-th user direction is the back direction of the positive speaker unit 1221 and the negative speaker unit 1221 of the n-th speaker unit pair 122.

Further, the positive speaker unit 1221 and the negative speaker unit 1221 of the n-th speaker unit pair 122 (n=1, . . . , N) are arranged in a positional relationship in which the sound emitted from the positive speaker unit 1221 and the sound emitted from the negative speaker unit 1221 are erased from each other so that a user who uses another seat cannot hear the sound.

The operations of the sound system 100 will be described in accordance with FIG. 14 in below.

The reproduction device 110 inputs a first acoustic signal, a third acoustic signal, . . . , and a 2N−1-th acoustic signal which are acoustic signals obtained based on the reproduction objects, and outputs the first acoustic signal, the second acoustic signal, . . . , and the 2N-th acoustic signal. More specifically, an n-th reproduction unit 112 (n=1, . . . , N) inputs a 2n−1-th acoustic signal, generates a 2n-th acoustic signal which is an acoustic signal having an opposite phase to that of the 2n−1-th acoustic signal from the 2n−1-th acoustic signal, and outputs the 2n−1-th acoustic signal and the 2n-th acoustic signal. The 2n−1-th acoustic signal and the 2n-th acoustic signal are respectively inputted to the positive speaker unit 1221 and the negative speaker unit 1221 of the n-th speaker unit pair 122.

The speaker system 120 inputs the first acoustic signal, the second acoustic signal, . . . , and the 2N-th acoustic signal outputted by the reproduction device 110, and emits a sound based on the first acoustic signal, a sound based on the second acoustic signal, . . . , and a sound based on the 2N-th acoustic signal. More specifically, the n-th speaker unit pair 122 (n=1, . . . , N) inputs the 2n−1-th acoustic signal and the 2n-th acoustic signal, and emits the sound based on the 2n−1-th acoustic signal from the positive speaker unit 1221, and emits the sound based on the 2n-th acoustic signal from the negative speaker unit 1221. Since the 2n−1-th acoustic signal and the 2n-th acoustic signal have an opposite phase relationship to each other, the sound can be heard only in the vicinity of the seat where the speaker system 120 is installed, as described in <Technical Background>. For example, in the case where N=2 is established, when the first acoustic signal and the third acoustic signal are respectively an acoustic signal of a right channel and an acoustic signal of a left channel of a certain sound source, a stereo sound can be heard only in the vicinity of the seat where the speaker system 120 is installed.

Note that the sound emitted in the n-th user direction from the positive speaker unit 1221 of the n-th speaker unit pair 122 and the sound emitted in an opposite direction to the n-th user direction from the positive speaker unit 1221 of the n-th speaker unit pair 122 have an opposite phase relationship to each other. Similarly, the sound emitted in the n-th user direction from the negative speaker unit 1221 of the n-th speaker unit pair 122 and the sound emitted in an opposite direction to the n-th user direction from the negative speaker unit 1221 of the n-th speaker unit pair 122 have an opposite phase relationship to each other.

According to the embodiment of the present invention, it is possible to reproduce the sound that can be heard only in the very limited narrow range in the vicinity of the speaker system. Note that the vicinity is a distance defined in consideration of experiment results based on environment in accordance with frequency and degree of sound erasure. For example, in the case where a state of the sound at a distance where a sound pressure at a position separated from the center of the speaker diaphragm by about the diameter of the speaker diaphragm is changed to a sound pressure equivalent to a background noise by gradually separating from the center of the speaker diaphragm is regarded as the erasure of the sound in <<3: Experiment Result>>, the “vicinity” is set to a distance separated from the center of the speaker diaphragm by about twice the diameter of the speaker diaphragm, for example. In addition, in another way, when an environment having a certain degree of background noise such as inside a vehicle is assumed, the range of vicinity is set so that a person sitting on the seat where the speaker system 120 is installed can hear and a person sitting on the adjacent seat cannot hear. For example, in the case where the sound radiated from the speaker unit is radiated to the periphery and becomes a sound pressure equivalent to the background noise is regarded as the erasure of the sound in <<3: Experiment Result>>, the “vicinity” can be regarded as a distance of about twice the shoulder width of the user from the center of the speaker diaphragm.

### Second Embodiment

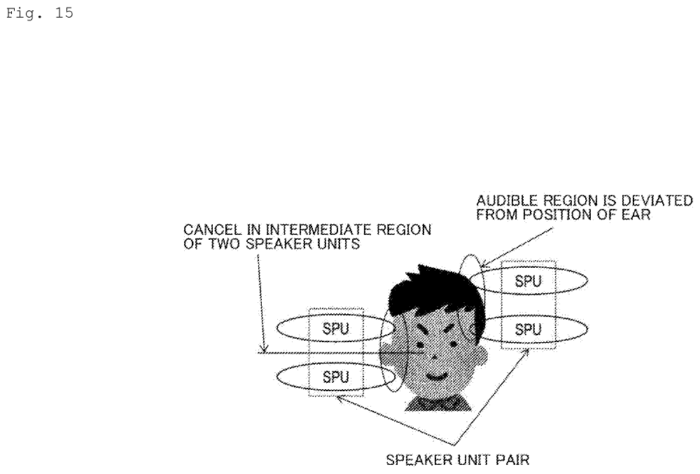

FIG. 15 is a diagram showing a situation of the sound emitted from the speaker unit pair. An SPU in the figure represents the speaker unit. In the case of the speaker unit pair installed near the right ear, sounds from the respective speaker units cancel each other in the intermediate region of the two speaker units, so that a region where the sounds emitted from the speaker unit pair cannot be heard is generated, and the user cannot hear the sounds. On the other hand, in the case of the speaker unit pair installed near the left ear, a region where the sound emitted from the speaker unit pair can be heard is deviated from the position of the ear, so that the user cannot hear the sounds. That is, (i) when both or either one of the right and left ears are located in the intermediate region, (ii) when both or either one of the right and left ears are deviated from the audible region, or (iii) when either one of the right and left ears is located in the intermediate region and the other is deviated from the audible region, a situation occurs in which a user cannot hear the sound or hardly hears the sound. In order to solve such a problem, the directivity of the sound emitted from the speaker unit pair is controlled. Here, a sound system for performing directivity control processing will be described.

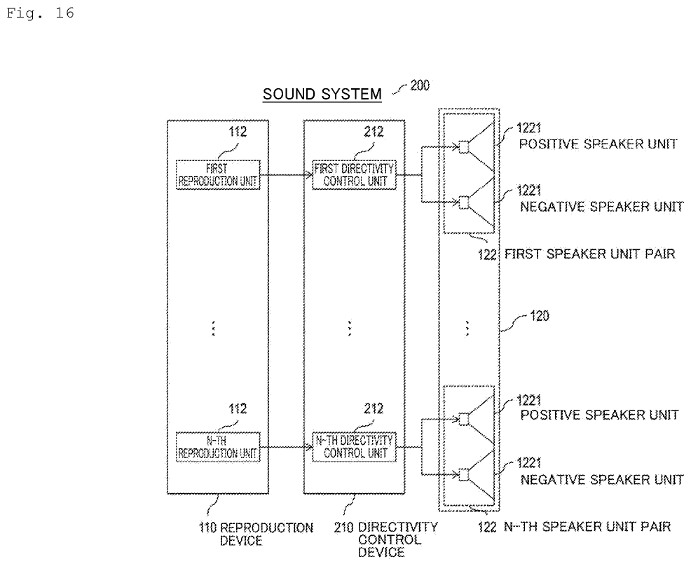

Hereinafter, a sound system 200 will be described with reference to FIG. 16. FIG. 16 is a block diagram showing a configuration of the sound system 200. As shown in FIG. 16, the sound system 200 includes the reproduction device 110, a directivity control device 210, and the speaker system 120. The directivity control device 210 includes N pieces of directivity control units 212 (that is, a first directivity control unit 212, an N-th directivity control unit 212).

The sound system 200 is different from the sound system 100 in that it includes the directivity control device 210.

In the following, the operations of the directivity control device 210 and the speaker system 120 will be described in accordance with FIG. 16.

The directivity control device 210 inputs the first acoustic signal, the second acoustic signal, . . . , and the 2N-th acoustic signal outputted by the reproduction device 110, and outputs a first processed acoustic signal which is a signal obtained by signal processing the first acoustic signal, a second processed acoustic signal which is a signal obtained by signal processing the second acoustic signal, and a 2N-th processed acoustic signal which is a signal obtained by signal processing the 2N-th acoustic signal. More specifically, a n-th directivity control unit 212 (n=1, . . . , N) inputs the 2n−1-th acoustic signal and the 2n-th acoustic signal, generates a 2n−1-th processed acoustic signal from the 2n−1-th acoustic signal and a 2n-th processed acoustic signal from the 2n-th acoustic signal by executing predetermined signal processing, and outputs the 2n−1-th processed acoustic signal and the 2n-th processed acoustic signal. Here, the predetermined signal processing is processing for controlling the directivity, and for example, a method of Reference Document 1, other directivity control techniques can be used. It is needless to say that the predetermined signal processing may be realized by the directivity control by other methods. In short, any technique may be used as long as the directivity control can be performed in accordance with the position of the user's ear and the position of the speaker unit pair.

(Reference Document 1) Futoshi Asano, “array signal processing of sound-localization, tracking and separation of sound source”, CORONA PUBLISHING CO., LTD, 2011, p. 69-91

The predetermined signal processing is, for example, filtering using an FIR (Finite Impulse Response) filter. The FIR filter used here is designed so that microphones are respectively installed in a region to be audible and a region not to be audible, that the value of the filter coefficient is made to approach 1 in the microphone installed in the region to be audible, and that the value of the filter coefficient is made to approach 0 in the microphone installed in the region not to be audible. This is described specifically hereinafter. The region to be audible and the region not to be audible need to be designed in accordance with the case. For example, a case to be installed in the seat (hereinafter referred to as a seat S) of the automobile is considered. A position where the ear is present when a user who uses the seat S moves the head or changes the direction of the face is included in the region to be audible, and a position where the ear is present when a user who uses a seat close to the seat S (for example, an adjacent seat or front and rear seats) moves the head or changes the direction of the face is included in the region not to be audible. Therefore, for example, in a microphone installed in the region including the seat close to the seat S but not including the seat S, the value of the filter coefficient is made to approach 0. Note that in consideration that the sound may not be heard even at the position where the ear is present when the head is moved or the direction of the face is changed because of the fact that the sounds cancel each other in the intermediate region between the two speaker units as described above, and the value of the filter coefficient in the microphone installed in the intermediate region is made to approach 1. In short, the microphone installed in the region where the user's ear is assumed to be present should be controlled so that the filter coefficient is made to approach 1, and the microphone installed in the region where the user's ear is assumed not to be present should be controlled so that the filter coefficient is made to approach 0. In other words, the filter may be configured so that the sound as large as possible may arrive in the region where the user's ear is assumed to be present, and the sound as small as possible may arrive in the region where the user's ear is assumed not to be present.

As a result, the n-th directivity control unit (n=1, . . . , N) executes the signal processing so that the sound emitted from the positive speaker unit of the n-th speaker unit pair and the sound emitted from the negative speaker unit of the n-th speaker unit pair can be heard in the region to be audible in the vicinity of the n-th speaker unit pair and cannot be heard in the region not to be audible. Note that the region to be the audible region includes a point located at an equal distance from the positive speaker unit of the n-th speaker unit pair and the negative speaker unit of the n-th speaker unit pair, in which the sound emitted from the positive speaker unit of the n-th speaker unit pair and the sound emitted from the negative speaker unit of the n-th speaker unit pair cancel each other.

The speaker system 120 inputs the first processed acoustic signal, the second processed acoustic signal, . . . , and the 2N-th processed acoustic signal outputted by the directivity control device 210, and emits the sound based on the first processed acoustic signal, and emits the sound based on the second processed acoustic signal, . . . , and the sound based on the 2N-th processed acoustic signal. More specifically, the n-th speaker unit pair 122 (n=1, . . . , N) inputs the 2n−1-th processed acoustic signal and the 2n-th processed acoustic signal, and emits the sound based on the 2n−1-th processed acoustic signal from the positive speaker unit 1221, and the sound based on the 2n-th processed acoustic signal from the negative speaker unit 1221.

### Modification Example

Here, a sound system in which a higher region sound is hardly leaked by using a member having a sound absorption characteristic will be described.

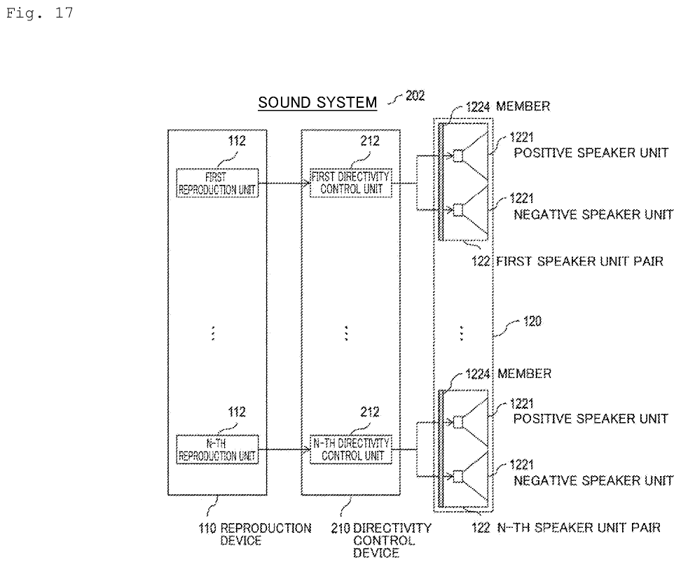

Hereinafter, a sound system 202 will be described with reference to FIG. 17. FIG. 17 is a block diagram showing a configuration of the sound system 202. As shown in FIG. 17, the sound system 202 includes the reproduction device 110, the directivity control device 210, and the speaker system 120, similarly to the sound system 200. However, the sound system 202 is different from the sound system 200 in that a member 1224 is attached to the speaker unit pair 122.

The structure of the n-th speaker unit pair 122 (n=1, . . . , N) will be described below in accordance with FIG. 17.

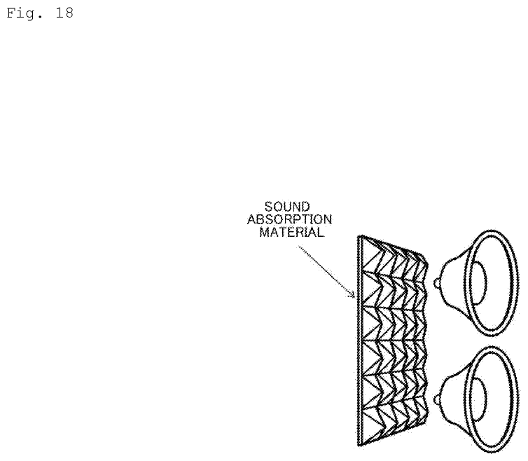

The n-th speaker unit pair 122 is provided with the member 1224 that absorbs sounds emitted in the opposite direction to the n-th user direction from the positive speaker unit 1221 and the negative speaker unit 1221 of the n-th speaker unit pair 122 (see FIG. 18). The member 1224 may be any member as long as it can prevent higher region sound from being radiated on the back. Note that instead of installing the member 1224 only on the back of the speaker unit pair 122, the member 1224 may be installed so as to surround other than the front of the speaker unit pair 122.

### Example of Sound System Installed in Seat of Automobile

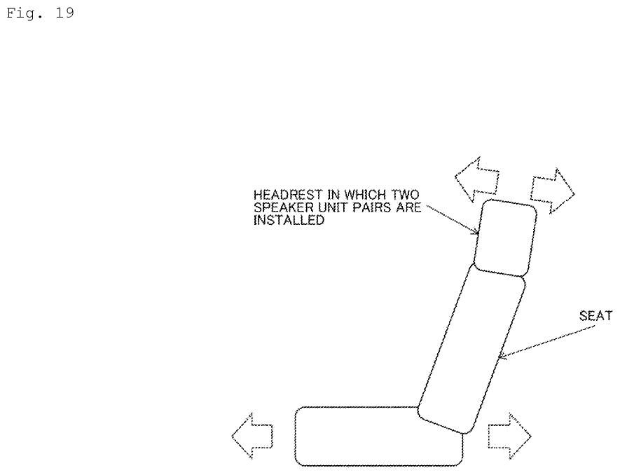

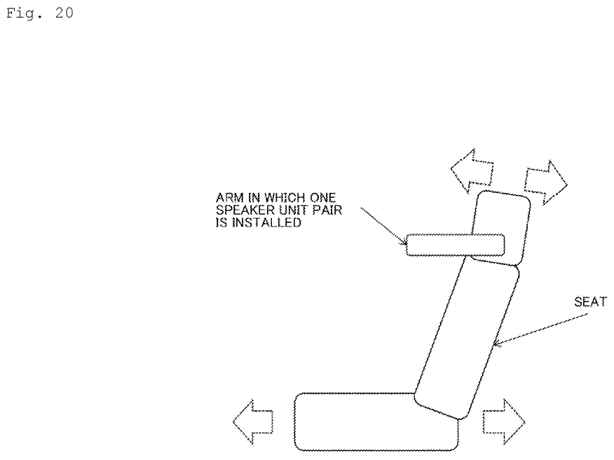

FIG. 19 and FIG. 20 are diagrams showing examples of sound systems installed in seats of automobiles, respectively. In the example shown in FIG. 19, a speaker unit pair is installed on a headrest of the seat of the automobile. Specifically, N=2 is established, and a first speaker unit pair and a second speaker unit pair are installed on the headrest of the seat of the automobile. On the other hand, in the example shown in FIG. 20, a speaker unit pair is installed on an arm that can be attached to the seat of the automobile. Specifically, N=2 is established, and the speaker unit pairs are respectively installed on two arms attached to the seat so as to sandwich the head of a user who uses the seat of the automobile. Note that the arm may be a movable type.

### Other Examples

Examples other than the seat of the automobile, specifically, a seat for an amusement machine such as a pachinko machine and a slot machine, will be described. Usually, a user uses a seat in front of the amusement machine to enjoy the amusement on the amusement machine. Therefore, the arm as described in the example of the automobile may be installed for the seat of the amusement machine, and the speaker unit pair may be present near the position where the ear of the user seated on the seat is present. Note that since the seat of the amusement machine has no backrest, the arm may be installed on the amusement machine instead of installing the arm on the seat. Alternatively, the arm may be a movable type, and the user may adjust the speaker unit pair so that the speaker unit pair is present near the ear.

### Third Embodiment

In the second embodiment, a case where an ear (hereinafter referred to as an auditory organ) may exist in deviation or a gap of an audible region (see FIG. 15), that is, a case where the positions of the speaker unit pair and the auditory organ are somewhat close to each other has been examined, but the present embodiment focuses on the positions of the speaker unit pair itself and the auditory organ. In other words, the directivity control which is rougher than that of the second embodiment will be examined in the present embodiment.

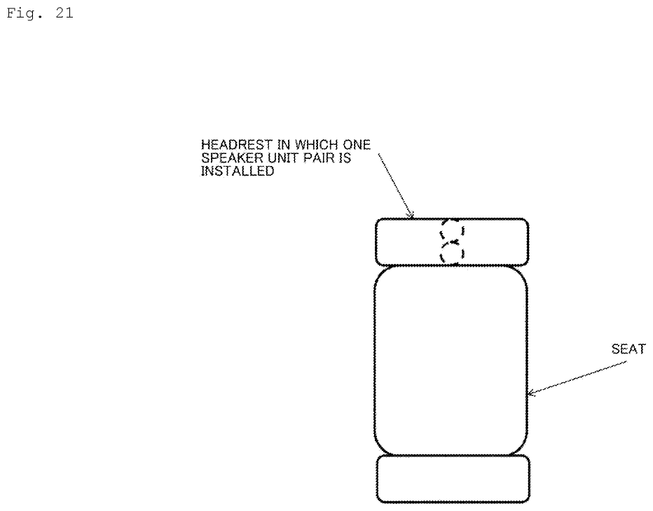

FIG. 21 is a diagram showing an example of a sound system installed on a seat of an aircraft. The sound system shown in FIG. 21 is installed on a headrest of the seat, and two speaker units included in one speaker unit pair are arranged side by side in a vertical direction at the center of the headrest. Note that although the seat of the aircraft is described as an example, it may be applied to a seat of an automobile, a seat of an electric train, an office chair, or a speaker unit pair installed in a separator or a digital signage. In short, the present embodiment can be applied to the technique described in the first embodiment, if it is necessary to make the audible region variable in accordance with the physical characteristics of the user represented by the height.

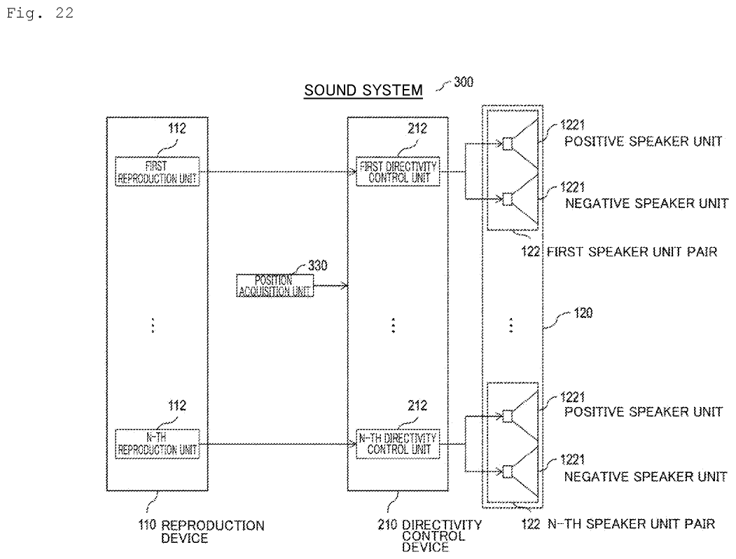

Hereinafter, a sound system 300 will be described with reference to FIG. 22. FIG. 22 is a block diagram showing a configuration of the sound system 300. As shown in FIG. 22, the sound system 300 includes the reproduction device 110, a position acquisition unit 330, the directivity control device 210, and the speaker system 120. The sound system 300 is different from the sound system 200 in that it includes the position acquisition unit 330.

Hereinafter, in accordance with FIG. 22, operations of the position acquisition unit 330 will be described. The position acquisition unit 330 changes the directivity of directivity control processing performed in the directivity control device 210 so that the directivity of the sound emitted by the speaker unit pair is directed to the position where the auditory organ of the user exists, in accordance with the position where the auditory organ of the user exists and the position where the speaker unit pair exists. Note that in the present embodiment, speakers are arranged side by side vertically in order to control the listening region in which the height of the user's auditory organs is emphasized. When the height of the auditory organs of the user is almost the same as in the case where the same user exclusively uses, the speakers may be arranged side by side to control the directivity in the lateral direction. It is preferable that the speaker closer to the ear position is a positive speaker unit and the speaker farther from the ear position is a negative speaker unit when the speakers are arranged vertically and horizontally. The switching of the roles of the positive and negative speakers is performed by a filter used in the directivity control device 210.

First, the position acquisition unit 330 acquires a position where the auditory organ of the user exists. Note that the position may be acquired through any method. An example in which the position acquisition unit 330 estimates the position and an example in which the user selects the position will be described below.

### Acquisition Method 1 (Position Estimation)

For example, the position acquisition unit 330 estimates the position of the user's head, and estimates the position where the auditory organ exists from the position of the head. Note that the position of the head may be estimated through any method.

For example, a pressure sensor is installed in the headrest, and it is estimated that the user's head exists at a position where strong pressure is applied.

Also, for example, the user's head is photographed by using a camera or the like, a feature amount is extracted from the photographed image, and a position where the head or the auditory organ of the user exists is estimated from the extracted feature amount.

Further, for example, when the headrest portion and the backrest portion of the seat have different members, the speaker unit pair is installed in the backrest portion, and the position of the headrest portion can be freely changed with respect to the backrest portion, the position of the headrest can be detected from a physical structure such as a state of a belt and a gear operating in conjunction with a position change of the headrest portion, the position where the user's head exists is estimated from the position of the headrest based on the assumption that the user's head exists at the position of the headrest. Note that, in this case, the speaker unit pair may be arranged side by side in a vertical direction with respect to the backrest portion where the head exists when a user of an average body shape sits on a seat.

### Acquisition Method 2 (User Selection)

For example, the position acquisition unit 330 has a selection unit such as a button that is not shown, and the user selects the position of the head or the auditory organ via the selection unit, a position where the auditory organ of the user exists may be acquired from the selection result. It is also possible to have a communication function that is not shown and to select from a terminal owned by a user. The terminal may be configured integrally with the sound system, or may be a terminal owned by a user such as a smartphone or a tablet.

Next, the position acquisition unit 330 selects a filter in which directivity of a sound emitted by the speaker unit pair is directed to a position where the auditory organ of the user exists, and sets the selected filter as a filter to be used in the directivity control device 210. In short, the position acquisition unit 330 changes a filter used in the directivity control device 210 in accordance with a positional relationship between the positions where the speaker unit pair exists and where the auditory organ of the user exists to change a region to be audible and a region not to be audible, and it is only necessary to design so that a position where the auditory organ of the user exists (a position assumed to exist) becomes the region to be audible, and a position where the auditory organ of the user does not exist (a position assumed not to exist) becomes the region not to be audible. Note that the positional relationship may be determined based on the estimated or selected positions of the head and the auditory organ and the reference location of the speaker unit pair (for example, the center position of the speaker unit pair, the center or lower end position of the speaker near the ground, etc.).

The filter may be obtained by calculation in advance by simulation or experiment, and stored in a storage unit that is not shown in association with the positional relationship between the positions where the speaker unit pair and where the auditory organ of the user exists. Instead of selecting the filter, the filter may be sequentially calculated so that the directivity of the sound emitted by the speaker unit pair is directed to the position where the auditory organ of the user exists.

### Control Example of Directivity

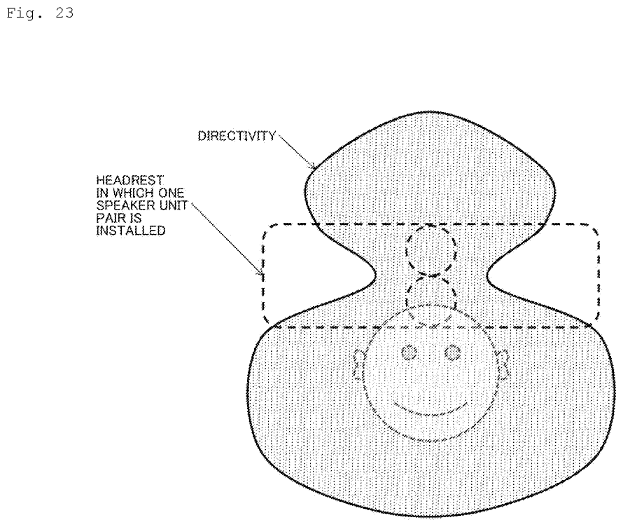

As shown in FIG. 23, when the position where the auditory organ of the user exists is lower than the position where the speaker unit pair exists, control is performed so that the directivity of the sound emitted by the speaker unit pair is directed to a lower direction.

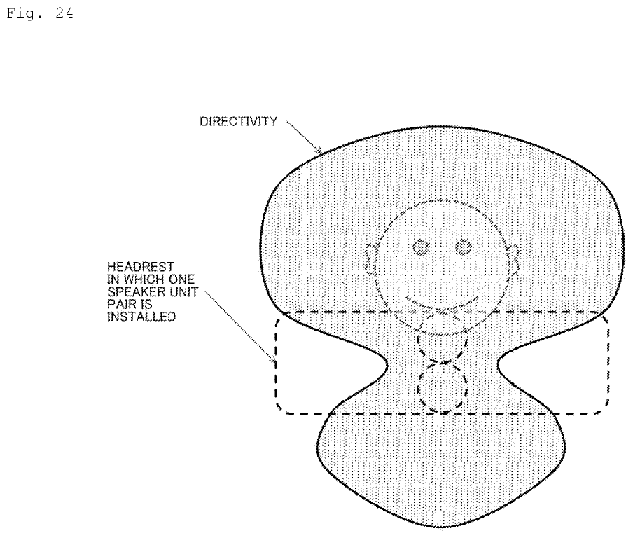

As shown in FIG. 24, when the position where the auditory organ of the user exists is higher than the position where the speaker unit pair exists, control is performed so that the directivity of the sound emitted by the speaker unit pair is directed to a higher direction.

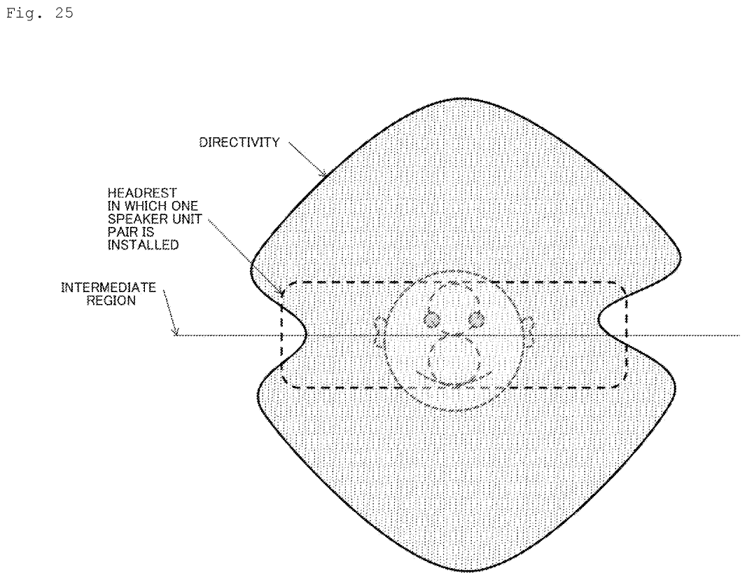

As shown in FIG. 25, when the position where the auditory organ of the user exists is substantially the same height as the position where the speaker unit pair exists, the directivity of the sound emitted by the speaker unit pair is controlled so that the user can hear the sound at a point located at equal distance from the positive speaker and the negative speaker. Note that when the position where the auditory organ of the user exists is substantially the same height as the position where the speaker unit pair exists, it means that the position where the auditory organ of the user exists exists on a plane (in short, the intermediate region of the second embodiment) formed by points located at equal distances from the positive speaker and the negative speaker. A filter designed so that a region (a region where sound pressure becomes lower) where directivity formed between the positive speaker and the negative speaker is not directed becomes small is selected. Note that, in this case, there is a trade-off relationship in which the sound leakage to the surroundings becomes larger as the region where the directivity is not directed (the region where the sound pressure becomes lower) is made smaller.

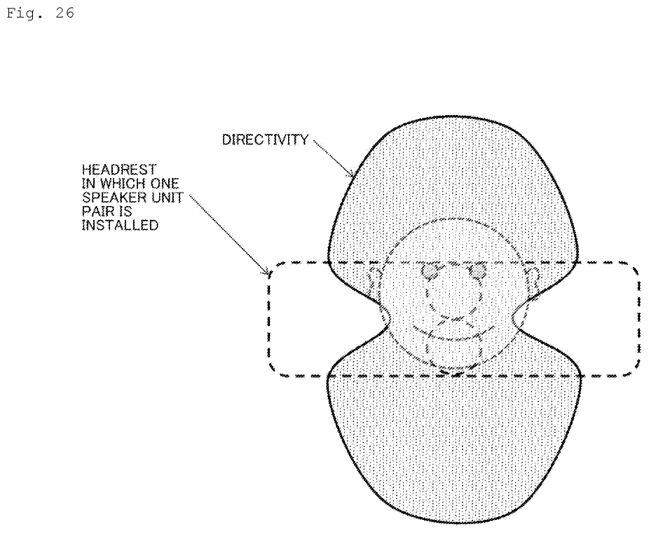

As shown in FIG. 26, when the position where the auditory organ of the user exists is substantially the same height as the position where the positive speaker or the negative speaker exists, the directivity of the sound emitted by the speaker unit pair is controlled so that the region where the user can hear becomes small. This control can reduce the sound leakage to the surroundings.

For example, a filter for achieving directivity as shown in FIG. 23, FIG. 24, FIG. 25, and FIG. 26 is obtained by simulation or experiment in advance, and stored in a storage unit that is not shown in association with the position where the auditory organ exists, the position acquisition unit 330 acquires the position where the auditory organ of the user exists, selects the corresponding filter from the storage unit that is not shown from the positional relationship between the speaker unit pair and the acquired position where the auditory organ of the user exists, and sets the selected file in the directivity control device 210.

In the directivity control device 210, processing is performed by using the filter selected by the position acquisition unit 330. Since the processing itself performed in the directivity control device 210 is similar to that of the second embodiment, the description thereof will be omitted.

Note that, as described in the second embodiment, the positive speaker and the negative speaker emit sounds in a predetermined direction so as to have opposite phases to each other in the region not to be audible. In addition, as described in the first embodiment, the positive speaker unit and the negative speaker unit are obtained by removing the speaker box from the speaker, and are arranged so that the sound emitted from the positive speaker unit in a direction opposite to the n-th user direction and the sound emitted from the negative speaker unit in a direction opposite to the n-th user direction are transmitted in the n-th user direction by wraparound.

According to the embodiment of the present invention, it is possible to reproduce the sound that can be heard only in a very limited narrow range in the vicinity of the speaker system, and it is possible to appropriately control the directivity in accordance with the position where the auditory organ of the user exists.

Note that the present embodiment and the modification example of the second embodiment may be combined.

Further, in the present embodiment, an example where N=1 is established has been described, but N may be any of integers of 2 or more, and even when N is an integer of 2 or more, localized reproduction can be performed, and the directivity can be appropriately controlled in accordance with the position where the auditory organ of the user exists.

### Modification Example 1

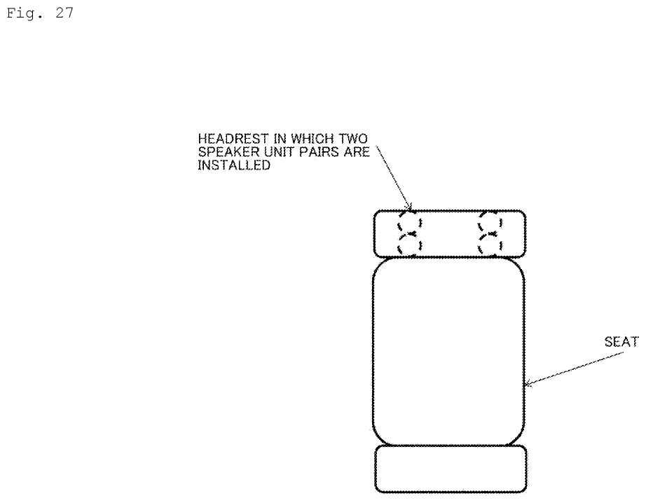

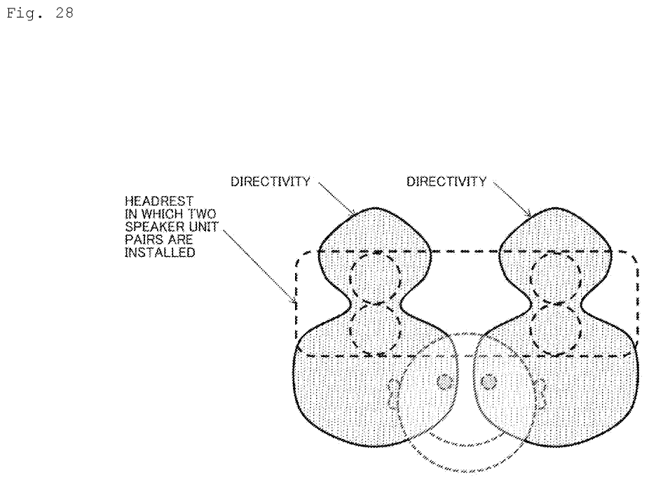

In the present embodiment, one speaker unit pair is installed on the headrest of the seat, but as shown in FIG. 27, two speaker unit pairs may be installed in the vicinity of positions where right and left auditory organs are assumed to exist on the headrest. As shown in FIG. 28, the directivity control similar to that of the third embodiment can be performed for each channel. The localized reproduction can be performed from each speaker unit pair to each auditory organ, and the directivity can be appropriately controlled in accordance with the position where the auditory organ of the user exists.

### Modification Example 2

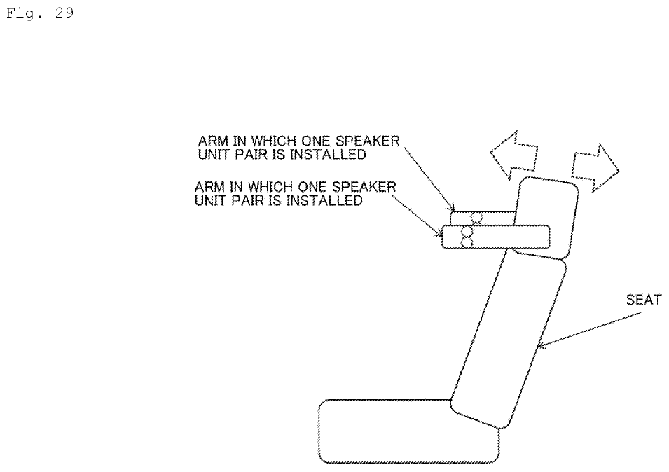

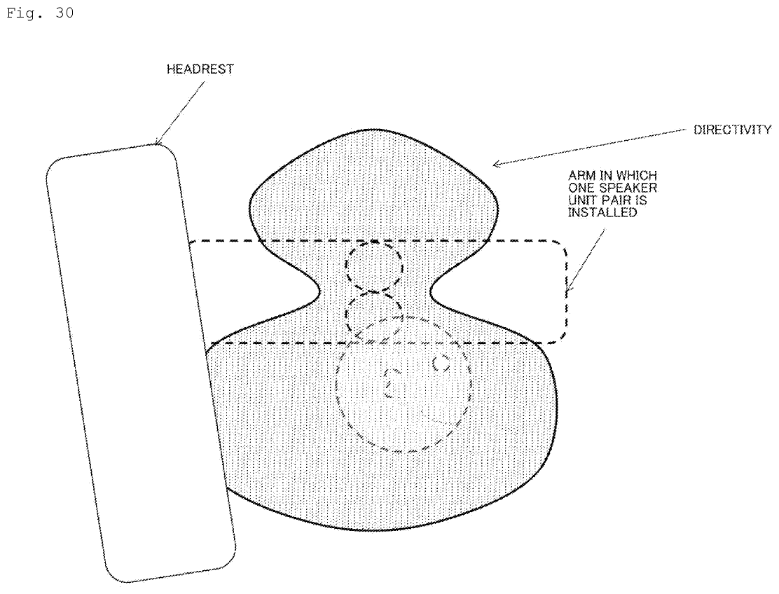

In addition, although two speaker unit pairs are installed on the headrest of the seat shown in FIG. 27, two speaker unit pairs may be installed on two arms which are attached to the seat and are not movable, respectively, as shown in FIG. 29. As shown in the figure, the directivity control similar to that of the third embodiment can be performed for each channel. Note that, in the present embodiment, the case where the speaker unit pair is installed in the backrest portion and the position of the headrest portion can be freely changed with respect to the backrest portion has been described, the headrest may inhibit sound emission of the speaker unit pair in this case. On the other hand, in the case of FIG. 30, since the speaker unit pair is installed on the arm, there is an advantage that the sound emission of the speaker unit pair is not inhibited.

### Modification Example 3

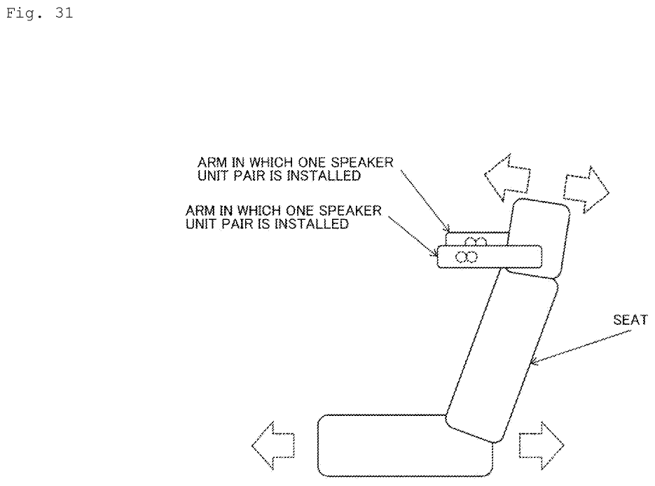

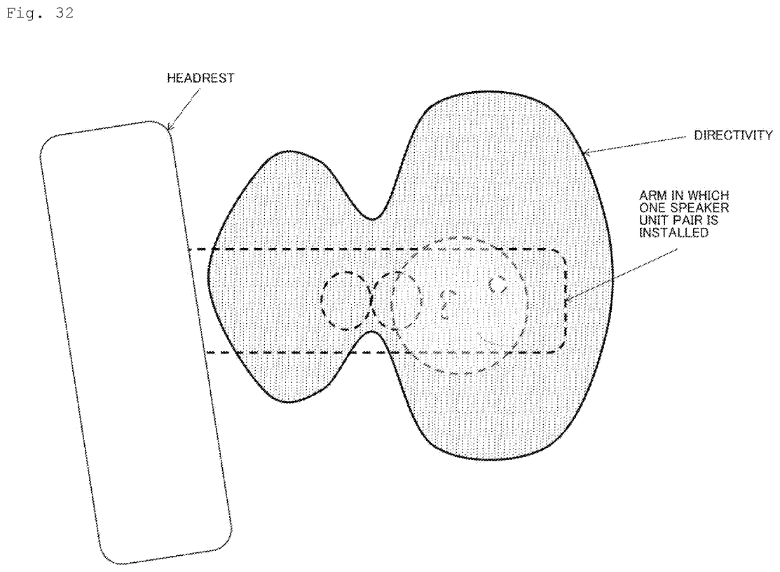

In FIG. 29 of the modification example 2, the two speaker units included in each speaker unit pair are arranged side by side in the vertical direction on each arm, but they may be arranged side by side in the horizontal direction as shown in FIG. 31. This configuration allows the directivity to be controlled in the forward and backward directions as shown in FIG. 32. Therefore, when the positions of the ears are moved in the forward and backward directions (leaning forward/throwing the body to the backrest), it is preferable that the two speaker units are arranged side by side in the horizontal direction.

Based on the direction where the user faces, the directivity is controlled so as to be directed to the forward direction when the head of the user is in front of the speaker unit pair and to the backward direction when the head of the user is behind the speaker unit pair. In short, the directivity is directed to the direction of the position of the head of the user, especially the position of the ear.

Also in this case, the position acquisition unit 330 acquires the position where the auditory organ of the user exists. Note that the position may be acquired through any method. An example in which the position acquisition unit 330 estimates the position and an example in which the user selects the position will be described below.

### Acquisition Method 1 (Position Estimation)

For example, the position acquisition unit 330 estimates the position of the user's head, and estimates the position where the auditory organ exists from the position of the head. Note that the position of the head may be estimated through any method.

For example, a tilt sensor is installed on the seat surface of the chair, and when the front surface of the chair is down and the tilt is equal to or greater than a predetermined amount, the user is presumed to be leaning the head forward, and the user's head is presumed to be in front of the speaker unit pair. When the back surface of the chair is down and the tilt is equal to or greater than a predetermined amount, the user is presumed to leaning to the backrest, and the user's head is presumed to be behind the speaker unit pair.

Also, for example, the user's head is photographed from the side by using a camera or the like, a feature amount is extracted from the photographed image, and a position where the head or auditory organ of the user exists is estimated from the extracted feature amount.

### Acquisition Method 2 (User Selection)

For example, the position acquisition unit 330 has a selection unit such as a button that is not shown, and the user selects the position of the head or the auditory organ via the selection unit, and the position where the auditory organ of the user exists may be acquired from the selection result.

Next, the position acquisition unit 330 selects a filter in which the directivity of the sound emitted by the speaker unit pair is directed to the position where the auditory organ of the user exists, and sets the selected filter as a filter to be used in the directivity control device 210. The processing itself in the directivity control device 210 is similar to that of the second embodiment, except that the directivity direction is different.

As shown in FIG. 32, when the position where the auditory organ of the user exists is in front of the position where the speaker unit pair exists, the directivity of sound emitted by the speaker unit pair is controlled so as to direct to the forward direction.

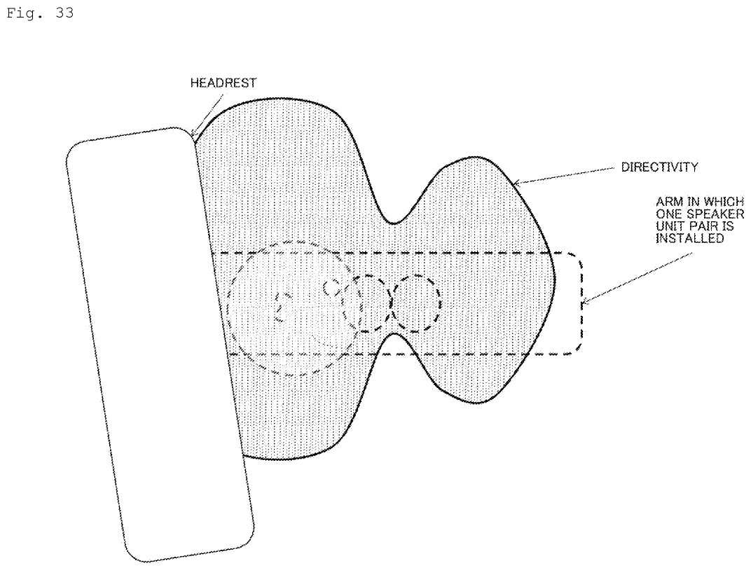

As shown in FIG. 33, when the position where the auditory organ of the user exists is behind the position where the speaker unit pair exists, the directivity of sound emitted by the speaker unit pair is controlled so as to direct to the backward direction.

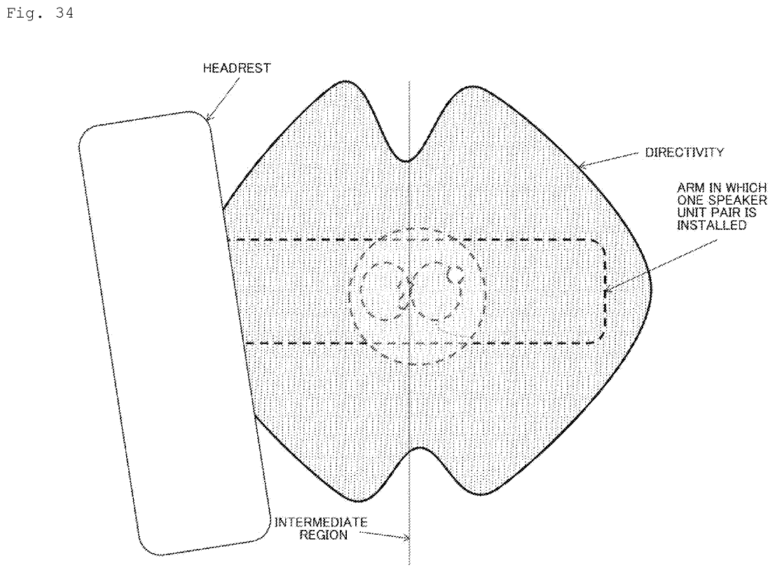

As shown in FIG. 34, when the position where the auditory organ of the user exists is substantially the same as the position where the speaker unit pair exists in the forward and backward direction, the directivity of the sound emitted by the speaker unit pair is controlled so that the user can hear the sound at a point located at equal distance from the positive speaker and the negative speaker. Note that when the position where the auditory organ of the user exists is substantially the same as the position where the speaker unit pair exists in the forward and backward direction, it means that the position where the auditory organ of the user exists exists on a plane (in short, the intermediate region of the second embodiment) formed by points located at equal distances from the positive speaker and the negative speaker. A filter designed so that a region (a region where sound pressure becomes lower) where the directivity formed between the positive speaker and the negative speaker is not directed becomes small is selected. Note that, in this case, there is a trade-off relationship in which the sound leakage to the surroundings becomes larger as the region where the directivity is not directed (the region where the sound pressure becomes lower) is made smaller.

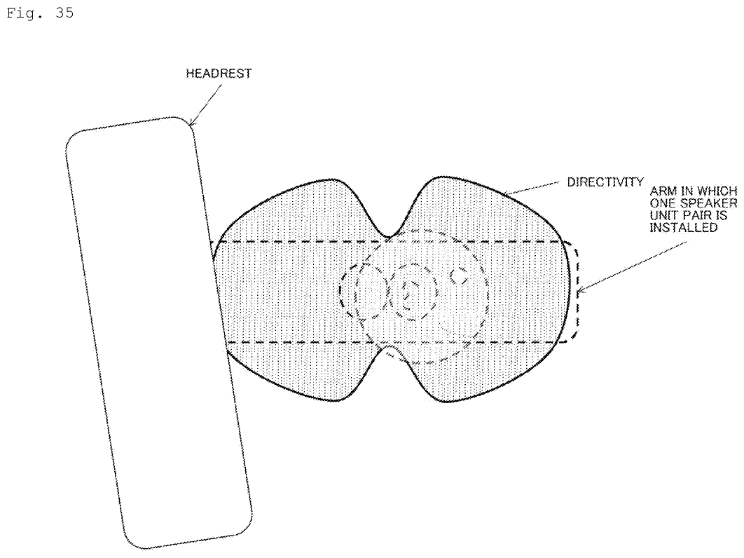

As shown in FIG. 35, when the position where the auditory organ of the user exists is substantially the same as the position where the positive speaker or the negative speaker exists in the forward and backward direction, the directivity of the sound emitted by the speaker unit pair is controlled so that the region where the user can hear becomes small. This control can reduce the sound leakage to the surroundings. Since the processing itself in the position acquisition unit 330 is similar to that of the third embodiment, the description thereof will be omitted.

### Modification Example 4

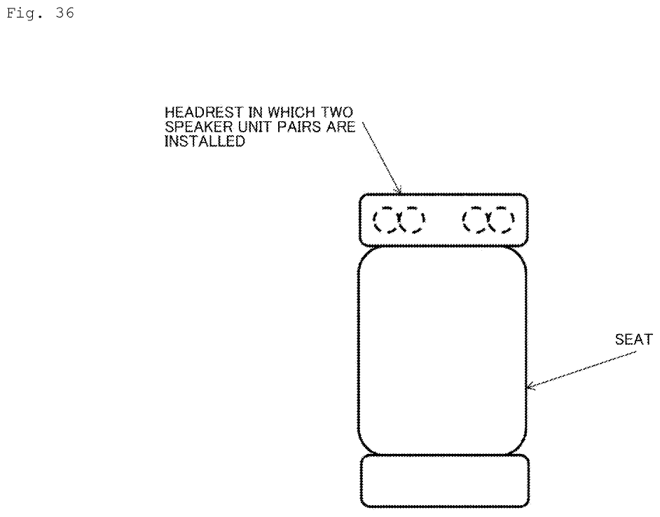

As shown in FIG. 36, two speaker unit pair may be installed in the vicinity of a position where the left and right auditory organs are assumed to exist on the headrest so that two speaker units included in each speaker unit pair are arranged side by side in the horizontal direction.

In the present modification example, the directivity control is performed in accordance with the size of the face and the positional relationship of the speaker unit pair.

In this case, the position acquisition unit 330 estimates the size of the user's face, and estimates the position where the auditory organ exists from the estimated size of the face. Note that the size of the user's face may be acquired through any method. An example in which the position acquisition unit 330 estimates the size of the user's face and an example in which the user selects the size of the user's face will be described below.

### Acquisition Method 1 (Estimation of Size of Face)

For example, the position acquisition unit 330 estimates the size of the user's face, and estimates the position where the auditory organ exists from the size of the user's face. Note that the size of the face may be acquired through any method.

For example, pressure sensors are arranged inside and outside with reference to a center line of the headrest, and when a difference between a pressure detected by the pressure sensor arranged inside and a pressure detected by the pressure sensor arranged outside is equal to or greater than a predetermined value, it may be judged that the face is a small face.

Also, for example, the user's head is photographed by using a camera or the like, a feature amount is extracted from the photographed image, and the size of the user's face is estimated from the extracted feature amount.

### Acquisition Method 2 (User Selection)

For example, the position acquisition unit 330 has the selection unit such as a button that is not shown, and the user selects the size of the face via the selection unit, the position where the auditory organ of the user exists may be acquired from the selection result.

Next, the position acquisition unit 330 selects a filter in which the directivity of the sound emitted by the speaker unit pair is directed to the position where the auditory organ of the user exists, and sets the selected filter as a filter to be used in the directivity control device 210. The processing itself is similar to that of the second embodiment except that the direction of directivity is different.

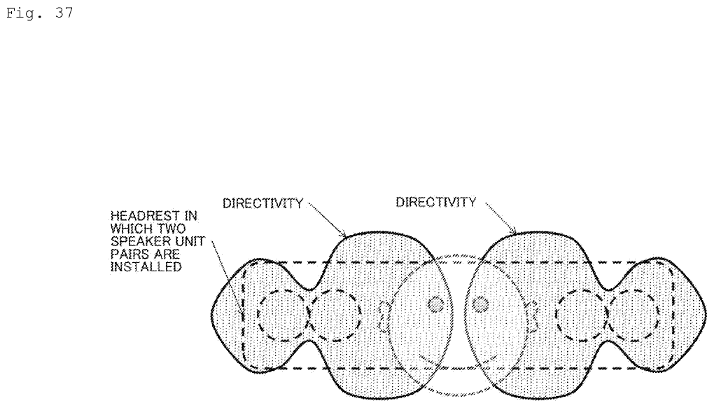

As shown in FIG. 37, when the user has a small face and the face fits between two speaker unit pairs, the directivity of the sound emitted by the speaker unit pair arranged on the left side is controlled to be directed to the right side and the directivity of the sound emitted by the speaker unit pair arranged on the right side is controlled to be directed to the left side based on the direction to which the user's face faces.

### Modification Example 5

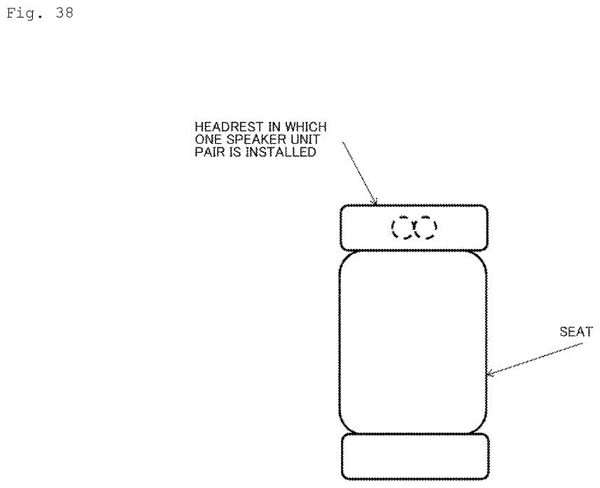

In the present modification example, as shown in FIG. 38, the sound system is installed on the headrest of the seat, and two speaker units included in one speaker unit pair are arranged side by side in the horizontal direction at the center of the headrest.

First, the position acquisition unit 330 acquires the position where the auditory organ of the user exists in the similar method of the present embodiment.

### Control Example of Directivity

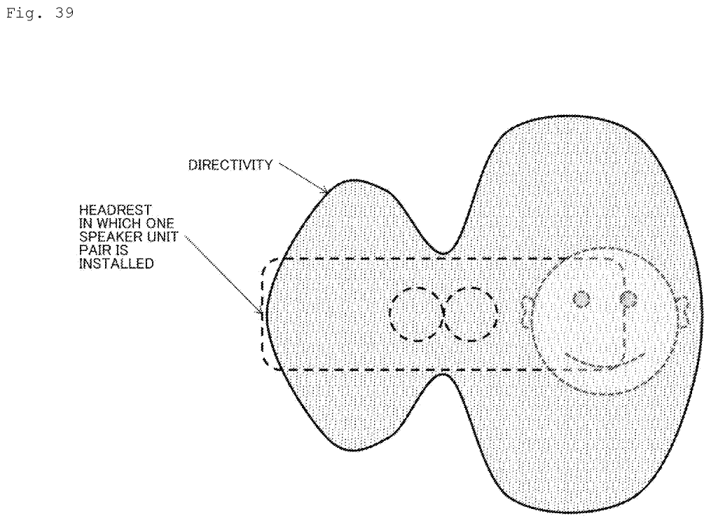

As shown in FIG. 39, when the position where the auditory organ of the user exists is on the left side of the position where the speaker unit pair exists, the directivity of the sound emitted by the speaker unit pair is controlled to be directed to the left direction.

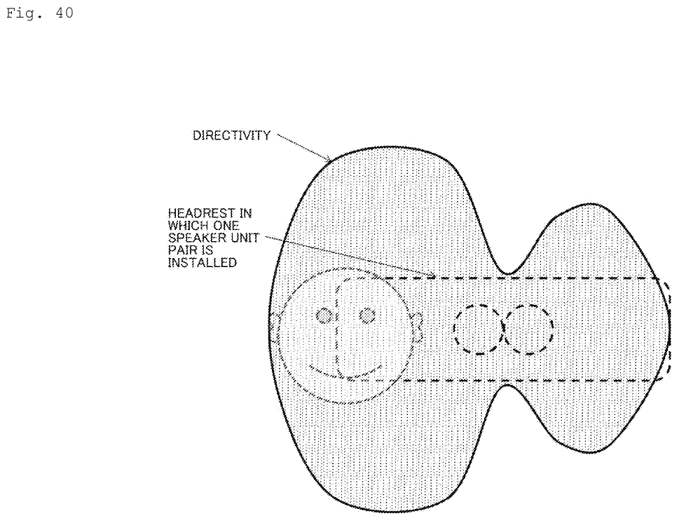

As shown in FIG. 40, when the position where the auditory organ of the user exists is on the right side of the position where the speaker unit pair exists, the directivity of the sound emitted by the speaker unit pair is controlled to be directed to the right direction.

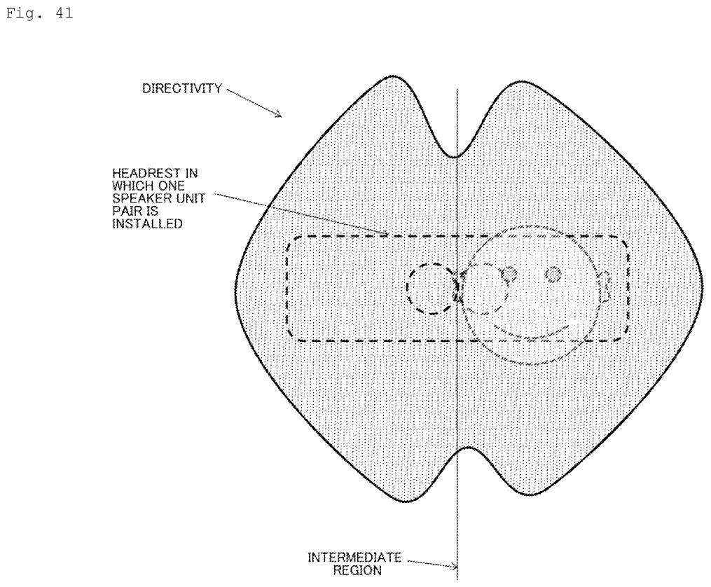

As shown in FIG. 41, when the position where the auditory organ of the user exists is substantially the same as the position where the speaker unit pair exists in the right and left direction, the directivity of the sound emitted by the speaker unit pair is controlled so that the user can hear the sound at a point located at an equal distance from the positive speaker and the negative speaker.

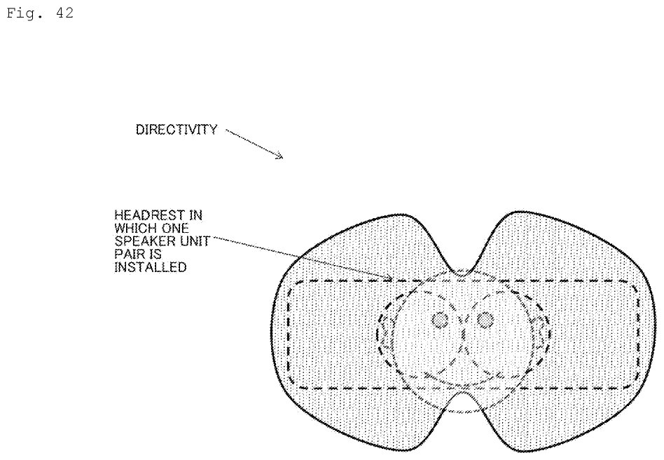

As shown in FIG. 42, when the position where the auditory organ of the user exists is substantially the same as the position where the positive speaker or the negative speaker exists in the right and left direction, the directivity of the sound emitted by the speaker unit pair is controlled so that the region where the user can hear is reduced.

Since the processing itself in the position acquisition unit 330 is similar to that of the third embodiment, the description thereof will be omitted.

### Modification Example 6

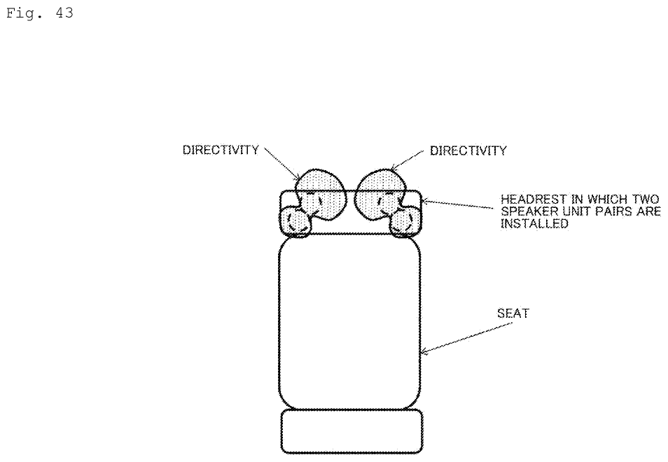

In the present modification example, as shown in FIG. 43, the sound system includes two speaker unit pairs installed on the headrest of the seat, two speaker units included in one speaker unit pair are arranged side by side from the lower right direction to the upper left direction, and two speaker units included in the other speaker unit pair are arranged side by side from the lower left direction to the upper right direction.

As shown in FIG. 43, this arrangement allows the right speaker unit pair to configure the directivity from the lower right direction to the upper left direction, and the left speaker unit pair to form the directivity from the lower left direction to the upper right direction. For example, when the auditory organ of the user is located between two speaker unit pairs in the left direction and right direction and the auditory organ of the user is located at a position higher than the two speaker unit pairs in the upper direction and lower direction, the directivity control can be more flexibly performed.

### Modification Example 7

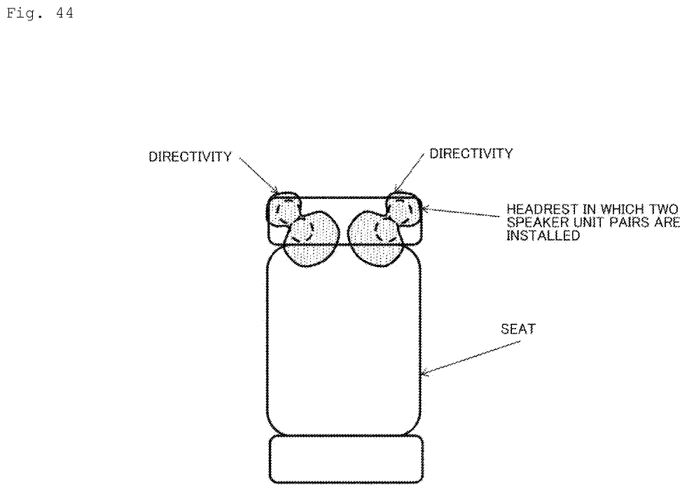

In the present modification example, as shown in FIG. 44, the sound system includes two speaker unit pairs installed on the headrest of the seat, two speaker units included in one speaker unit pair are arranged side by side from the upper right direction to the lower left direction, and two speaker units included in the other speaker unit pair are arranged side by side from the upper left direction to the lower right direction.

As shown in FIG. 44, this arrangement allows the right speaker unit pair to configure the directivity from the upper right direction to the lower left direction, and the left speaker unit pair to form the directivity from the upper left direction to the lower right direction. For example, when the auditory organ of the user is located between two speaker unit pairs in the left direction and right direction and the auditory organ of the user is located at a position lower than the two speaker unit pairs in the upper direction and lower direction, the directivity control can be more flexibly performed.

### Additional Note

The above description of the embodiments of the present invention is presented for the purpose of illustration and description. There is no intention to be exhaustive and there is no intention to limit the invention to a disclosed exact form. Modifications or variations are possible from the above-mentioned teachings. The embodiments are selectively represented in order to provide the best illustration of the principle of the present invention and in order for those skilled in the art to be able to use the present invention in various embodiments and with various modifications so that the present invention is suitable for deliberated practical use. All of such modifications or variations are within the scope of the present invention defined by the appended claims interpreted according to a width given fairly, legally and impartially.

1. A sound system comprising:
a directivity control device configured to comprise processing circuitry configured to implement at least one directivity control unit that generates a first processed acoustic signal from an acoustic signal (hereinafter referred to as a first acoustic signal) of a predetermined sound source and a second processed acoustic signal from an acoustic signal (hereinafter referred to as a second acoustic signal) having an opposite phase to that of the first acoustic signal by executing predetermined signal processing; and
a speaker system configured to comprise at least one speaker unit pair that comprises a speaker (hereinafter referred to as a positive speaker) that emits a sound based on the first processed acoustic signal and a speaker (hereinafter referred to as a negative speaker) that emits a sound based on the second processed acoustic signal, wherein
the positive speaker and the negative speaker do not comprise a speaker box,
the signal processing executed by the directivity control unit is processing that gives directivity to the sound emitted by the speaker unit pair, and
the directivity of the sound emitted by the speaker unit pair is controlled depending on a position where an auditory organ of a user exists, and a position where the speaker unit pair exists.

2. The sound system according to claim 1, wherein
the directivity of the sound emitted by the speaker unit pair is controlled so as to direct to a lower direction, when the position where the auditory organ of the user exists is lower than the position where the speaker unit pair exists, and controlled so as to direct to a higher direction, when the position where the auditory organ of the user exists is higher than the position where the speaker unit pair exists.

3. The sound system according to claim 1, wherein
the directivity of the sound emitted by the speaker unit pair is controlled so that the user can hear at a point located at an equal distance from the positive speaker and the negative speaker, when the position where the auditory organ of the user exists is substantially the same height as the position where the speaker unit pair exists.

4. The sound system according to claim 1, wherein
the directivity of the sound emitted by the speaker unit pair is controlled so that a region where the user can hear is reduced, when the position where the auditory organ of the user exists is substantially the same height as the position where the positive speaker or the negative speaker exists.

5. The sound system according to claim 1, wherein
the directivity of the sound emitted by the speaker unit pair is controlled so as to direct to a forward direction, when the position where the auditory organ of the user exists is in front of the position where the speaker unit pair exists, and
controlled so as to direct to a backward direction, when the position where the auditory organ of the user exists is behind the position where the speaker unit pair exists.

6. The sound system according to claim 1, wherein
the directivity of the sound emitted by the speaker unit pair is controlled in accordance with a size of a user's head.
